(19) United States
(12) Patent Application Publication
(10) Pub. No.: US 2021/0395490 A1
(43) Pub. Date: Dec. 23, 2021

(54) COMPOSITION COMPRISING POLYOLEFIN AND GIBBSITE

(71) Applicants: BASELL POLYOLEFINE GMBH, WESSELING (DE); ALBERT-LUDWIGS-UNIVERSITAT FREIBURG, FREIBURG (DE)

(72) Inventors: SHAHRAM MIHAN, BAD SODEN (DE); ROLF MUELHAUPT, FREIBURG (DE); FAN ZHONG, FREIBURG (DE)

(73) Assignees: BASELL POLYOLEFINE GMBH, WESSELING (DE); ALBERT-LUDWIGS-UNIVERSITAT FREIBURG, FREIBURG (DE)

(21) Appl. No.: 17/284,745

(22) PCT Filed: Oct. 10, 2019
(86) PCT No.: PCT/EP2019/077450

§ 371 Date: Apr. 12, 2021

(30) Foreign Application Priority Data
Oct. 11, 2018 (EP) 18199918.6

(51) Int. Cl. C08K 9/06; C08K 3/22; C09C 1/40; C09C 3/12

(52) U.S. Cl. CPC C08K 9/06; C08K 3/22; C08K 2201/011; C09C 3/12; C08K 2003/2227; C09C 1/407

(57) ABSTRACT

A polyolefin composition made from or containing (a) a polyolefin and (b) a gibbsite nano platelet treated with a compound of formula (OR^{a})₃Si—R^{b} or of formula R^{c}—COOH wherein R^{a} is a C₁-C₁₀ alkyl radical; R^{b} is a C₅-C₃₀ alkyl radical and R^{c} is a C₅-C₃₀ hydrocarbon radical.

### FIELD OF THE INVENTION

In general, the present disclosure relates to the field of chemistry. More specifically, the present disclosure relates to polymer chemistry. In particular, the present disclosure relates to a modified gibbsite and a polyolefin composition made from or containing the modified gibbsite.

### BACKGROUND OF THE INVENTION

In some instances, gibbsite nano platelet (γ-Al(OH)₃) is synthesized from Al(NO₃)₃·9H₂O as precursor after hydrothermal crystallization.

In some instances, polyolefins are tailored to specific purposes. For instance, polyethylene is widely used in the automobile industry. In some instances, polyethylene or polypropylene is additivated inter alia with mineral fillers to improve stiffness. In some instances, fillers adversely affect impact behavior.

### SUMMARY OF THE INVENTION

In a general embodiment, the present disclosure provides a polyolefin composition made from or containing (a) a polyolefin and (b) a gibbsite nano platelet treated with a compound of formula (OR^{a})₃Si—R^{b} or of formula R^{c}-COOH wherein R^{a} is a C₁-C₁₀ alkyl radical; R^{b} is a C₅-C₃₀ alkyl radical and R^{c} is a C₅-C₃₀ hydrocarbon radical.

### DETAILED DESCRIPTION OF THE INVENTION

In some embodiments, the present disclosure provides a filler for a polyolefin composition made from or containing an organophilic nano platelet gibbsite. In some embodiments, the organophilic nano platelet gibbsite is a nano platelet gibbsite treated with compound of formula (OR^{a})₃Si—R^{b} or of formula R^{c}—COOH wherein R^{a} equal to or different from each other is a C₁-C₁₀ alkyl radical; R^{b} is a C₅-C₃₀ hydrocarbon radical and R^{c} is a C₅-C₃₀ hydrocarbon radical.

In some embodiments, the present disclosure provides a polyolefin composition made from or containing:
A) from 95 wt % to 10 wt % of a polyolefin; and
B) from 5 wt % to 90 wt % of an organophilic nano platelet gibbsite;
   the sum of the amount of A and B being 100 wt %. In some embodiments, the organophilic nano platelet gibbsite is a nano platelet gibbsite treated with compound of formula (OR^{a})₃Si—R^{b} or of formula R^{c}—COOH wherein R^{a} equal to or different from each other is a C₁-C₁₀ alkyl radical; R^{b} is a C₅-C₃₀ hydrocarbon radical and RC is a C₅-C₃₀ hydrocarbon radical.

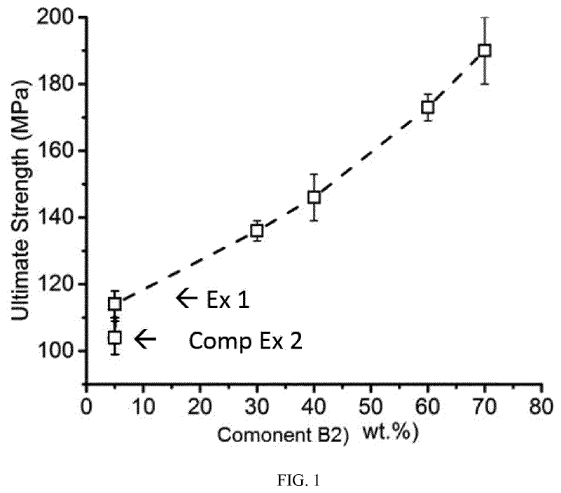

FIG. 1 is a graph showing the ultimate strength versus the amount of component B) of examples and comparative examples 1-6.

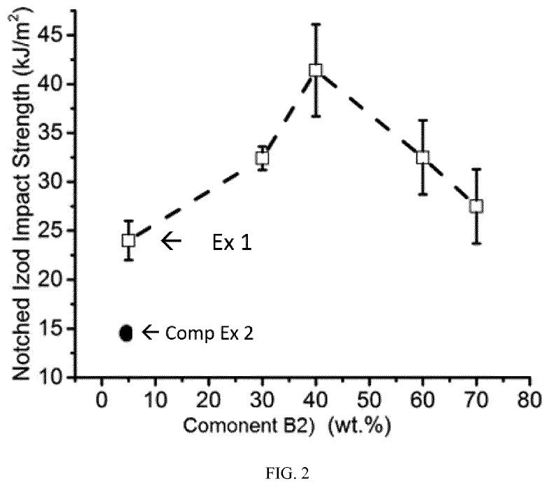

FIG. 2 is a graph showing notched Izod impact strength versus the amount of component B) of examples and comparative examples 1-6.

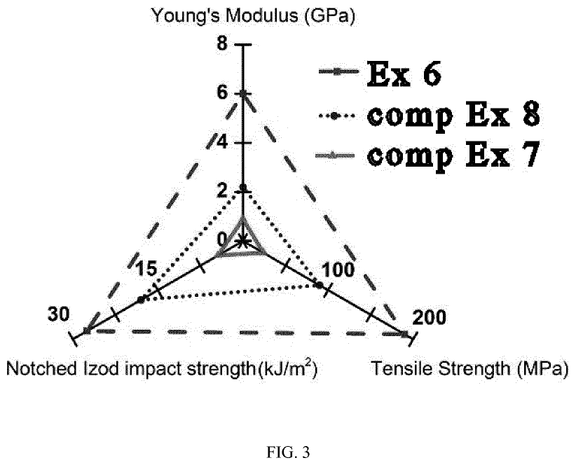

FIG. 3 is a graph showing the Young's modulus, notched impact strength and tensile strength of example 7, and comparative examples 7 and 8.

In some embodiments, the polyolefin is selected from poly alpha olefins. In some embodiments, the polyolefin is selected from the group consisting of polypropylene homopolymers, polypropylene copolymers, polyethylene homopolymers, polyethylene copolymers, and blends of ethylene or propylene polymers optionally with other comonomers. In some embodiments, the comonomers are selected from the group consisting of 1-butene, 1-hexene and 1-octene.

In some embodiments, gibbsite nano platelet (γ-Al(OH)₃) is synthesized from Al(NO₃)₃·9H₂O as precursor after hydrothermal crystallization.

The morphology of gibbsite is characterized with SEM and TEM. In some embodiments, gibbsite shows pseudo hexagonal structure with a length of 700 nm, thickness of 30 nm. The thermal gravity analysis on gibbsite indicates that gibbsite shows a thermal stability until 260 ° C. and decomposes at temperatures higher than 260 ° C. with loss of water. The residual mass of gibbsite at 650 ° C. is 66.44% and matches the theoretical value. Infrared (IR) characterization shows sharp peaks around 3500 cm⁻¹, indicating free stretch —OH group.

Organophilic nano platelet gibbsite is a gibbsite, wherein some OH groups are functionalized, thereby rendering the material less polar.

In some embodiments, the organophilic nano platelet gibbsite is obtained by treating the nano platelet gibbsite with compound of formula (OR^{a})₃Si—R^{b} or of formula R^{c}—COOH wherein R^{a} is a C₁-C₁₀ alkyl radical; R^{b} is a C₅-C₃₀ hydrocarbon radical and R^{c} is a C₅—C₃₀ hydrocarbon radical. Without being bound to any theory, it is believed that the compounds of formula (OR^{a})₃Si—R^{b} or formula R^{b}—COOH react with at least some of the OH groups present on the surface of the Gibbsite nano platelet to form an organophilic-modified gibbsite nano platelet. In some embodiments, the difference between the gibbsite nano platelet and the organophilic-modified gibbsite nano platelet is seen by suspending the two materials in toluene and then treating the suspension with an ultrasonic bath. The organophilic-modified gibbsite nano platelet is dispersed uniformly and does not settle while the gibbsite nano platelet forms a sediment immediately after the ultrasonic bath is switched off

In the compound of formula (OR^{a})₃Si—R^{b}, R^{a} is a C₁-C₁₀ alkyl radical; R^{b} is a C₅-C₃₀ hydrocarbon radical; alternatively R^{a} is a C1-C8 alkyl radical; alternatively R^{a} is a C1-C₄ alkyl radical. In some embodiments, R^{a} is a C1-C4 alkyl radical selected from the group consisting of methyl, ethyl isopropyl n-propyl, tertbutyl, n-butyl, and sec butyl. In some embodiments, R^{b} is a C₅-C₃₀ linear or branched alkyl, alkenyl, or alkynyl radical, alternatively R^{b} is a C₁₀-C₂₀ linear or branched alkyl, alkenyl, or alkynyl radical, alternatively R^{b} is a C₁₀-C₂₀ linear alkyl, alkenyl, or alkynyl radical. In some embodiments, the compound of formula (OR^{a})₃Si—R^{b} is trimethoxy (octadecyl) silane.

In the compound of formula R^{c}—COOH, R^{c} is a C₅-C₃₀ hydrocarbon radical; alternatively R^{c} is a linear or branched C₅-C₃₀, alkyl, alkenyl, or alkynyl radical, alternatively R^{c} is a C₁₀-C₂₀ linear or branched C₅-C₃₀, alkyl, alkenyl, or alkynyl radical, alternatively R^{c} is a C₁₀-C₂₀ linear alkyl, alkenyl, or alkynyl radical, such as fatty acids. In some embodiments, the fatty acid is stearic acid.

In some embodiments and in the polyolefin composition, component A) ranges from 95 wt % to 30 wt %; alternatively from 75 wt % to 40 wt % and component B) ranges from 5 wt % to 70 wt %; alternatively from 25 wt % to 60 wt %.

In some embodiments, the polyolefin composition is used with other additives. In some embodiments, the polyolefin composition is pelletized and compounded using compounding and blending methods.

In some embodiments, the polyolefin composition is used for the production of molded articles. In some embodiments, the molded articles are injection-molded articles. In some embodiments, the injection-molded articles are automotive articles.

The following examples are given to illustrate and not to limit the present disclosure.

### EXAMPLES

### Properties Characterization.

The tensile test was conducted with Zwick Z-005 (ZwickRoell) at 23 ° C., using dumb-belled test specimen according to DIN-EN-ISO 527 (5A) (LxBxH: 75 mm×4 mm×2 mm) and at least 6 specimens were tested.

Notched Izod impact strength was performed using a Zwick pendulum equipped with 2 J hammer in accordance with DIN-EN-ISO 180 and at least 4 specimens were tested.

The fracture surface after measurement was analyzed by Scanning Electron Microscopy (SEM) of Quanta FEG 250 (FEI) to investigate the fracture mechanism.

The nacre-like structure was characterized by Scios Dualbeam Focused Ion Beam/Scanning Electron Microscopy (FIB/SEM) from Thermo Fischer. The operation conditions were under vacuum condition, and the cross-section was in-situ polished by the ionic beam and imaged by SEM. 3D images and video were reconstructed depending on 160 image slides. Each slide had a thickness of 100 nm. 3D reconstruction software was AVIZO from Thermo Fischer.

Thermal gravimetric analysis (TGA from Netzsch STA 409C) was conducted to determine incorporated Component B) content in the temperature range from 50 ° C. to 650 ° C. with a heating rate of 10 K/min in the N2 atmosphere. Thermal properties were determined by DSC 204F1 Phenix from Netzsch, heating and cooling were conducted under N2 atmosphere with a heating rate of 1 K/min in the temperature range from 20 ° C. to 180 ° C. Self-healing procedure was conducted in a vacuum oven at 120 ° C. with different mending time of 2h, 4h and 8h. The tensile test specimens were cut with a home-made knife (see S-2) causing a crack of 50 p.m width and 1.2 mm depth without total breaking. The healing effect was evaluated in two aspects including morphology and tensile test. The healing efficiency was calculated as a function of xx and at least 3 specimens were tested.

### Component B1 Comparative)

### Synthesis of Gibbsite Nano Platelet

Gibbsite nano platelet (γ-Al(OH)₃) was synthesized from Al(NO₃)₃·9H₂O as a precursor after hydrothermal crystallization. The preparation procedure was described in Schema 1.

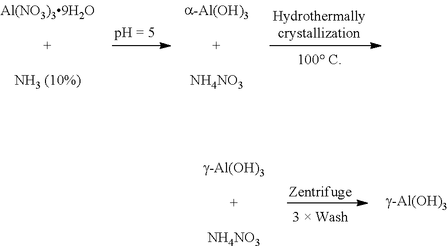

96.23 g Al(NO₃)₃·9H₂O was dissolved in 1923 g deionized water. Then, dropwise ammonia in a solution at 10 wt.-% in water was added to adjust the pH to 5 at room temperature with a vigorous stirring to form a homogenous white gel-like solution. The homogenous white gel-like solution was treated in oven at 100° C. for 10 days. The supernatant liquid was removed. The sediment was centrifuged at 7500 rpm for 30 minutes and washed 3 times with deionized water to purify the product. 20 g of wet gibbsite was obtained. The gibbsite was stored in a wet state.

### Component B2 Exemplified)

### Synthesis of Organophilic Nano Platelet Gibbsite

The wet state gibbsite (about 20 g) was dispersed in 300 ml of a mixture containing 75 ml deionized water and 225 ml of ethanol in a 500 ml two necked flask. The mixture was treated with ultrasonic bath at room temperature for 30 min. Then 5 ml (of a 20 wt.-% solution of trimethoxy (octadecyl) silane was added. The suspension was heated at 75° C. for 12 h with stirring (500 rpm). After 12 h, the suspension was cooled. The supernatant liquid was removed. The sediment was purified by centrifuge with a rate of 7500 rpm for 20 min and washed 2 times with EtOH. The organophilic gibbsite was dried.

### Preparation of the Polyethylene A1

### Component 1)

2-((1-(trimethylsilyl)-indenyl)-methyl)pyridin-CrC12 (as described in Patent Cooperation Treaty Publication No. WO 2011/089017).

### Component 2)

Bis(n-butyl-cyclopentadienyl)hafnium dichloride, commercially available from Chemtura Inc.

### Catalyst System

250 mg of component B2) was dried overnight under vacuum at 100° C. Then component B2) was dispersed in 20m1 toluene using an ultrasonic bath for 30 min. 0.85 ml of methylalumoxane (MAO 30 wt % in toluene, commercially available from Chemtura Inc) was added and stirred for 30 min. The powder was permitted to settle. The supernatant toluene was removed. The powder was washed twice with 20 ml toluene and then twice with 20 ml of heptane with separation by decantation. A solution of 4.4 mg Component A1) and 3.4 mg of the chromium complex component A2) in 2 ml toluene was added to the support. The suspension was stirred for one hour. The supernatant liquid was decanted. The powder was resuspended in 20 ml of heptane, thereby yielding a 20 ml solution with ˜70 μmol/g active components.

### Polymerization

400 ml isobutane were loaded in an autoclave under nitrogen. The reactor was flashed twice by 2 bar ethylene to remove the nitrogen. The reactor was pressurized to 30 Bar with ethylene. 1 ml (corresponding to 12.5 mg of support) was added to the reactor through a feeding valve. The reaction was carried out under stirring for one hour at 65° C. The resulting polyethylene had a density of 0.9256 g/cm³.

### Example 1

A blend of 20 wt % of the polyethylene eAl 75 wt % of HDPE (component A2) (Hostalen GC7260; Melt flow rate=23 g·10 min, 190 ° C., 2.16 kg, commercially available from LyondellBasell) and 5 wt % of component B2 were physically mixed by a rotating mixer (RRM mini 80) from J. Engelsmann AG for 1 h. Then, this composite was dried at 60 ° C. in a vacuum oven for 16 h and melt compounded with co-rotating twin-screw micro compounder Xplore™ (DSM) at 200 ° C. with a rotation speed of 120 rpm for 2 min. The subsequent micro-injection molding (Xplore™, DSM) was performed with a constant injection pressure of 0.7 MPa, constant injection duration time of 4.5 s (1.Phase=0.5 s, 2. Phase=1.5 s, 3.Phase=2.5 s) and constant mold temperature of 40 ° C.

### Comparative Example 2

Example 1 was repeated by using component B1 instead of component B2. Strength, stiffness and toughness of the materials of examples 1 and comparative example 2 were measured. The results are graphically shown in FIGS. 1-3.

### Examples 3-6

Example 1 was repeated by using respectively 30 wt %, 40 wt %, 60 wt %, and 70 wt % of component B2 and respectively, 50 wt %, 40 wt %, 20 wt % and 10 wt %. The amount of component A2 was maintained constant at 20 wt %.

The analysis of the materials are graphically shown in FIGS. 1-2.

### Comparative Examples 7 and 8.

Component A2 alone (comparative example 7) and a blend of 80 wt % of component A2 and 20 wt % of component Al (comparative example 8) were compared with the material of example 6. The results are graphically shown in FIG. 3.

What is claimed is:

1. A polyolefin composition comprising:
A) from 95 wt % to 30 wt % of a polyolefin;
B) from 5 wt % to 70 wt % of a nano platelet gibbsite treated with compound of formula (OR^{a})₃Si—R^{b} wherein R^{a} equal to or different from each other is a C₁-C₈ alkyl radical and R^{b} is a C₅-C₃₀ hydrocarbon radical.

2. The polyolefin composition according to claim 1, wherein in component B) in the compound of formula (OR^{a})₃Si—R^{b}, R^{a} is a C₁-C₄ alkyl radical.

3. The polyolefin composition according to claim 1, wherein in component B) in the compound of formula (OR^{a})₃Si—R^{b}, R^{b} is a C₅-C₃₀ linear or branched alkyl, alkenyl, or alkynyl radical.

4. The polyolefin composition according to claim 1, wherein in component B) in the compound of formula (OR^{a})₃Si—R^{b}, R^{b} is a C₁₀-C₂₀ linear or branched alkyl, alkenyl, or alkynyl radical.

5. The polyolefin composition according to claim 1, wherein in component B) in the compound of formula (OR^{a})₃Si—R^{b}, R^{b} is a C₁₀-C₂₀ linear alkyl, alkenyl, or alkynyl radical.

6. The polyolefin composition according to claim 1, wherein in component B) the compound of formula (OR^{a})₃Si—R^{b} is trimethoxy (octadecyl) silane.

7. The polyolefin composition according to claim 1, wherein component A) is selected from the group consisting of polypropylene homopolymers, polypropylene copolymers, polyethylene homopolymers, polyethylene copolymers, and mixtures thereof.

8. The polyolefin composition according to claim 1, wherein component A) is a polyethylene homopolymer or copolymer.

9. The polyolefin composition according to claim 1, wherein component A) ranges from 75 wt % to 40 wt %; and component B) ranges from 25 wt % to 60 wt %.
